(19) United States
(12) Patent Application Publication
(10) Pub. No.: US 2012/0146762 A1
(43) Pub. Date: Jun. 14, 2012

(54) METHOD AND SYSTEM FOR MONITORING A PLURALITY OF ELEMENTS IN A SAFETY PROCEDURE

(76) Inventors: Paolo Osvaldo Agnelli, Milano (IT); Stefano Lambertini, Monza (IT); Massimo Citterio, Milano (IT); Edoardo Vittorio Agnelli, Milano (IT); Giuseppe Radaelli, Milano (IT); Marcello Ortona, Milano (IT)

(21) Appl. No.: 13/377,512

(22) PCT Filed: Apr. 20, 2010
(86) PCT No.: PCT/EP2010/055207

§ 371 Date: Feb. 20, 2012

(30) Foreign Application Priority Data
Jun. 19, 2009 (IT) MI2009A001094

(51) Int. Cl. G06F 7/04

(52) U.S. Cl. 340/5.2

(57) ABSTRACT

The method according to a preferred embodiment of the present invention allows monitoring that a plurality of preliminary actions is performed, before an operation is authorised. In particular a controller device operated by a user must be brought into close proximity with a predetermined set of entities (e.g. safety garments). Only when all the required safety garments are detected, the user is authorised to perform the operation. As an example, the method of the present invention can be used in safety procedure, divided in predetermined operation steps, comprising the following stages: a first stage, in which a remote system asks to carry out said operation step by means of telecommunication; a second stage, in which a human operator carries out said operation step; a third stage, in which a tag, located in a place associated to said operation step, is detected; a fourth stage, following said third stage, in which said detection is notified to said remote system, by means of telecommunication; a further stage, following at least one from among said first, third or fourth stage, in which instructions for carrying out said operation according to said standard procedure are displayed electronically in a format which is intelligible for said human operator.

### FIELD OF THE INVENTION

The present invention relates to the field of data processing systems and more particularly to a method and system for ensuring that safety rules are respected in a work environment, by monitoring a plurality of safety elements with a proximity based communication device.

### BACKGROUND OF THE INVENTION

In order to limit as much as possible the risk to workers' safety in industrial activities, strict safety regulations are normally defined, in particular when accessing area which are considered potentially dangerous for the people working within such areas. A number of critical operations must be performed before accessing such areas or during the period spent in the areas. The critical operations must be performed according to procedural regulations capable of assuring a certified safety standard.

It is to be noted that said procedural regulations may concern not only what is to be performed in itself, but also the correct time and procedure sequences.

However, it is difficult for a single operator, even well instructed and skilled, to remember exactly all the single steps to be performed in accordance with these procedural regulations.

Consequently, it is common to use a paper manual, which describes how these steps must be performed according to the procedural regulations.

Advantageously, the manual reports exactly the single steps in a way that is simple for an operator to understand and with unambiguous meaning, so as not to cause possible different interpretations.

Meeting perfectly such a requirement is not simple. The manual often reports generalizations that the operator must keep in mind. However, this brings about the possibility of misinterpretation by the operator, which could cause safety level decrease.

One example could be a general introductory chapter saying: “all the steps described by the following procedures must be performed wearing accident prevention clothes”. However, such introductory chapter might not be taken seriously enough by the operator, who consequently might not give the right importance to the use of these accident prevention clothes. Furthermore, on performing the operation, the operator might not be able to remember which accident prevention clothes are to be worn (safety helmet, shoes, etc.). It is to be noted that sometimes the correct use of the accident prevention clothes could be difficult and the operator could be inclined to “simplify” his activity neglecting the use of such accident prevention clothes, putting at risk his safety. A generalization is also used to describe identical procedures which have to be repeated, for example, on different machines or different systems. However, this reduces the intelligibility of the instructions reported in the manual and consequently, determines a further cause of the onset of interpretation errors, and therefore a possible loss of safety.

To avoid generalizations the manual should report not only all the necessary steps provided by each single procedural regulation, but also all the possible combinations of machines and devices, on which the procedures are carried on. Obviously, this is not possible, and therefore, a certain degree of generalization and consequently, a possibility of confusion with a resulting loss of safety, are normally accepted.

Moreover, besides the specific issues connected with the generalizations, it can happen that an unskilled or absent-minded operator skips a step described in the manual, thus putting at risk his own, and possibly others' safety.

Furthermore, since the industrial plants are often modified over time, new manuals must be prepared, which is not only expensive and onerous, but can also generate confusion and reduce safety, in the case an old manual has not been substituted with a new one.

Furthermore, the operator carries out orders which are given by means of paper documents, normally called “Work Orders” and “Work Permits”, which report the operation to be carried out and the related safety procedural regulations, including operational practice and safety equipment; however, failing to control or verify regularly correspondence of the activity actually carried out with the one required by said paper documents is a widespread working habit. This results in the fact that, in some cases, the operator works on things not indicated in the “Work Permits”, taking risks which could be very serious or even bring to fatal accidents.

Therefore, it is necessary to put in place some control steps which “force” the individual worker to comply with the safety regulations. The known methods are normally not flexible or not strict enough to guarantee an acceptable safety level.

On the other hand, a human control process would be extremely complex to be organised, very expensive and not completely safe.

### Object of the Invention

An object of the present invention is to alleviate at least some of the problems associated with the prior art systems.

According to one aspect of the present invention there is provided a method for monitoring a plurality of entities by means of a controller device, the controller device including a proximity based communication transceiver, each of the plurality of entities including a proximity based tag adapted to interact with the transceiver, each tag carrying identity information adapted to identify the associated entity, the method including: maintaining in a repository, accessible by the controller device, a list of entities which must enter into the transmission range of the proximity based communication transceiver before the performance of an operation is authorized; responsive to the detection of a tag within the transmission range, the controller device reading the information associated to the detected tag; the controller device checking the inclusion of the entity corresponding to the read information in the list of entities; responsive to all the entities of the list being detected, the controller device issuing an authorization. In a preferred embodiment of the present invention such detection of all entities in the list must occur within a predetermined period of time, in order to obtain the authorization.

The method according to a preferred embodiment of the present invention allows monitoring that a plurality of preliminary actions is performed, before an operation is authorised. In particular a controller device operated by a user must be brought into proximity with a predetermined set of entities (e.g. safety garments). Only when all the required safety garments are detected, the user is authorised to perform the operation.

According to another embodiment of the present invention the controller device is a portable device, possibly including NFC transmission means. For example it could be a mobile phone with NFC functionality. Alternatively the proximity based communication could be implemented by means of an RFID transmission device, while RFID tags can be applied on the plurality of entities. An entity can be any object the presence (or use) of which must be monitored. In particular a safety procedure could require that a set of safety garments are detected before entering an area or starting an operation.

The repository containing information on the entities to be detected can be local to the controller device, e.g. on the device internal memory or a removable memory card (e.g. an SD memory card); alternatively the repository could be remote and accessible by the controller device by mean of a network, e.g. a GSM network, or a WiFi or the Internet.

According to an embodiment of the present invention, the controller device issues a message to the user, e.g. in the form of a sound, a light (e.g. a flashing light) or a message represented on a screen, for communicating the grant or the denial of the authorisation.

In a further embodiment the controller device is connected to switching means capable of activating or de-activating access means, e.g. a gate or a door to access an area; the issuing of the communication by the controller device can be followed by a controller signal which activates such switching means.

In another embodiment a server controls the operations of the controller device. The server can be properly instructed to manage a complete procedure, requiring the detection of several entities and the order and the timing of such detections.

According to a second aspect of the present invention there is provided a system comprising one or more components adapted to perform the method described above.

According to a third aspect of the present invention there is provided a computer program comprising instructions for carrying out the method described above when said computer program is executed on a computer system.

In this way, it is possible to overcome the typical limitations of a paper manual, so that the operation steps of the procedure can be carried out under the guide of electronic devices, making the versatility of information systems available to an operator.

### BRIEF DESCRIPTION OF DRAWINGS

Reference will now be made, by way of example, to the accompanying drawings, in which:

FIGS. 1 to 4 illustrate a first embodiment of the present invention;

FIGS. 5 to 8 illustrate a second embodiment of the present invention.

### DETAILED DESCRIPTION OF THE EMBODIMENTS

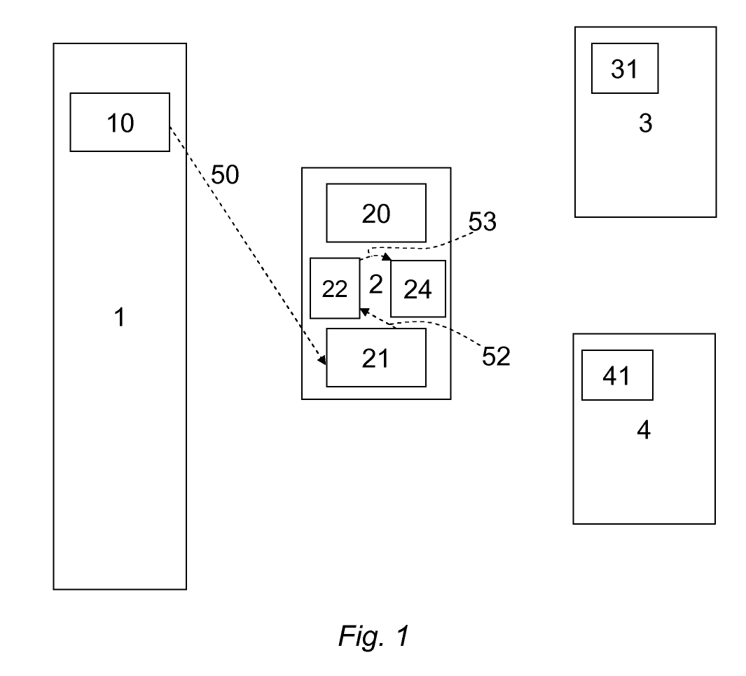

FIGS. 1 to 4 show a preferred embodiment of the present invention using an implementation example for a safety procedure to be enforced in a work environment. The method according to a preferred embodiment of the present invention allows monitoring that a plurality of preliminary actions are performed, before an operation (e.g. the access to a restricted area or the handling of a dangerous tool) is authorised. In particular a controller device and a predetermined set of entities (e.g. safety garments) must come into close proximity one each other. Only when all the required safety garments are detected, the user is authorised to perform the operation. In an embodiment of the present invention, the controller device could be connected with switching means which control the access to a restricted area (e.g. through a door or an access gates): the issue of the authorisation could cause the activation of the switching means, so that the access is physically enabled (e.g. the access gates opens) when all the conditions are fulfilled.

As an example, the method of the present invention can implement a safety procedure, which is divided in predetermined operation steps, comprising, for at least one of said operation steps, the following stages: a first stage, in which a remote system asks to carry out said operation step by means of telecommunication; a second stage, in which a human operator carries out said operation step; a third stage, in which a tag, located in a place associated to said operation step, is detected; a fourth stage, following said third stage, in which said detection is notified to said remote system, by means of telecommunication; a further stage, following at least one from among said first, third or fourth stage, in which instructions for carrying out said operation according to said standard procedure are displayed electronically in a format which is intelligible for said human operator. Preferably, the third stage uses a portable device, with which the human operator is equipped, and the first and the fourth stages use a radio communication between the remote system and the portable device. It is to be noted that the portable device, capable of transmitting and receiving data, and at the same time, of visualizing texts and audiovisuals, is a device widely known in the art and is almost always less heavy and bulky with respect to a paper manual.

In particular, the radio communications are of the type using GSM or wi-fi. Alternatively other solutions could be adopted, e.g. storing information on a memory card according to SD standards, or connecting the device with a cable (e.g. USB cable). Preferably, the portable device is a cellular telephone. This is particularly advantageous, because it allows technical simplification of the incorporation of the present invention. Preferably, the third stage is carried out by means of a proximity sensor and a tag detectable by said proximity sensor. A proximity sensor/tag system in itself is known in the state of the art. The proximity sensor is capable of detecting the presence of a tag only when the distance between the proximity sensor and the tag is smaller than a predetermined threshold.

Thus, when an operator has to execute an operation step, he has to be in the proximity of the place, in which the tag is located. In order to confirm that said operation step has been carried out, the operator brings the proximity sensor close to the tag, so that the proximity sensor is capable of identifying the tag. It will be appreciated that a tag is capable of reporting an unambiguous code; therefore the device is able to identify precisely the detected tag from among a plurality of tags positioned in the environment, in which the operation is carried out. In the state of the art, a tag is normally a device of small dimensions, which can be easily applied to existing elements. The fact that the tag is detectable by an electronic device allows a great simplification of the operator's actions: he just needs to bring the proximity sensor close to the tag to perform the required step. According to a preferred embodiment of the present invention, the third stage is carried out by means of a radio communication according to NFC standard. NFC (Near Field Communication) is a standard communication protocol, widely employed in state of the art cellular telephones and thus allows the portable device to take shape of a common mobile telephone with an integrated proximity sensor. Examples of NFC enabled mobile phones include Nokia 6212 classic; Nokia 6131NFC, BenQ T80, Motorola L7(SLVR) NFC, Samsung SGH-D500E NFC, Samsung SGH-X700n (brick) NFC, Sagem-Orga my700X NFC, Nokia 3220+NFC Shell.

This further simplifies the realization of the present invention. Known NFC tags can be integrated in supports as small as a credit card.

According to a particularly preferred embodiment, in the third stage a tag located on accident prevention clothes is detected, in particular a safety helmet or accident prevention shoes. In this way, when the operator is asked to wear a determined piece of accident prevention clothes, he is supposed to bring his proximity sensor close to the required entity of accident prevention clothes, so as to show that it is in place (e.g. worn). It is a very simple and natural action for the operator. Of course the opposite movement could be done, i.e. bringing the required entity into close proximity with the controller device; this is for example the case where the controller device is fixed, e.g. on a wall, at the entrance of an access gate.

Additionally, some operation steps can simply require operator's confirmation after he has read and possibly confirmed the information related to the operation being carried out.

According to a preferred embodiment of the present invention, performance instructions related to one or more of the operation steps in accordance with said standard procedure can be displayed in a format intelligible to the human operator, and a reading acknowledgement is requested before continuing said method.

The invention also relates to a distributed apparatus for operation according to a method of a preferred embodiment of the present invention.

With reference to FIGS. 1 to 4, a first embodiment of the present invention is shown.

This first embodiment defines a method for safe carrying out e.g. building operation in a building site. According to a standard procedure, in accordance with current regulations, for example in such building operation, a worker should wear a safety helmet, schematically represented with the reference number 3, and accident prevention boots, schematically represented with 4, as shown in FIG. 1.

These accident prevention clothes 3, 4 are equipped with tags 31, 41, respectively, according to the Near Field Communication or NFC standard (see the protocols ISO4 15693, 18092, 21481, ECMA5 340, 356, ETSI6 TS 102 90). As it is known, said tags 31, 41 include radio power supplied microprocessor systems capable of communicating, again by radio, with the devices which supply them with power. Such tags 31, 41 are applied to the accident prevention clothes 3, 4 in a permanent way. Those skilled in the art will easily appreciate that NFC protocol is only one of the possible implementing solutions, but any device and transmission protocol capable of realizing a proximity based communication can be used instead: e.g. an RFID transceiver and related RFID tags could be used.

The worker is equipped with a controller device 2, which is equipped with:
first radio communication means 21, capable of radio transmitting and receiving according to GSM and/or wi-fi standards (according to variants, other communication protocols or arrangements could also be used, not necessarily wireless communication standards;
an input/output interface 24 e.g. including a keyboard and a display, for example an LCD (according to variants, sound means could also be used, for example a beep type, mainly for alarms and urgent communications);
second radio communication means 20, capable of radio transmitting and receiving (transceiver) according e.g. to the NFC standard with the tags 31, 41;
a microprocessor 22, capable of managing the cellular telephone 2 functionalities by means of dedicated software (for example, by means of a Java language application).

It will be appreciated that the cellular telephone 2 can be of known type in itself, since the NFC standard is implemented on normal, widely used cellular telephones (e.g. one of those mentioned above). The NFC standard allows bidirectional communication between said second radio communication means 20 and said tags 31, 41, only at a close range, for example about 5 cm. According to an embodiment of the present invention, a remote system 1 is provided, such as a server for example, whose task is to guide the worker in carrying out the building operation according to predefined safety standards. This remote system 1 can be installed in a room of the building company that carries out the above mentioned building operation. A repository (e.g. a database) is maintained in the server and is made accessible by the controller device. The repository includes a safety procedure and a list including a plurality of entities which must enter into the transmission range of the proximity based communication transceiver before the performance of an operation is authorized.

The remote system 1 can include third radio communication means 10, capable of radio transmitting and receiving to and from the cellular telephone 2, according to GSM and wi-fi standards.

The embodiment here described is arranged with mobile controller devices, which can connect with a server by means of a wireless communication network. However it is possible that the controller device is fixed, e.g. on a wall next to an access gate: people entering the gate, must obtain the access authorisation bringing the required entities (e.g. helmet and boots) with the NFC (or RFID or other communication protocol) tag into close proximity with the controller device. In such case the controller device can communicate with the server with wired connection. Also it might be not necessary that the controller device is connected to a server or even can be connected to a network: the information on the safety procedure and on the necessary steps to comply with the procedure (including the list of elements to be detected) might be included on the device itself, e.g. on the internal memory or a removable memory card (e.g. SD card).

An example of operation of the present invention will be now illustrated for a predetermined building operation, for which the standard procedure includes carrying out at least the two following operation steps:
putting on an accident prevention safety helmet 3;
putting on accident prevention shoes 4.

The first operation step is described below.

A stage is provided, in which the worker is asked to put on an accident prevention helmet 3. It can happen in the following way:
the remote system 1 transmits a GSM type request signal 50 to the first radio communication means 21 of the cellular telephone 2;
the microprocessor 22 acquires (stage 52) the received request signal 50; in this way, the microprocessor 22 is able to identify that the request 50 relates to the fact that the accident prevention helmet 3 is worn;
the microprocessor 22 asks (stage 53) the input/output interface 24 to display the request to put on the accident prevention helmet 3.

According to the invention, there is also a stage, in which the operator carries out said working stage. Therefore, the worker puts on the accident prevention helmet 3.

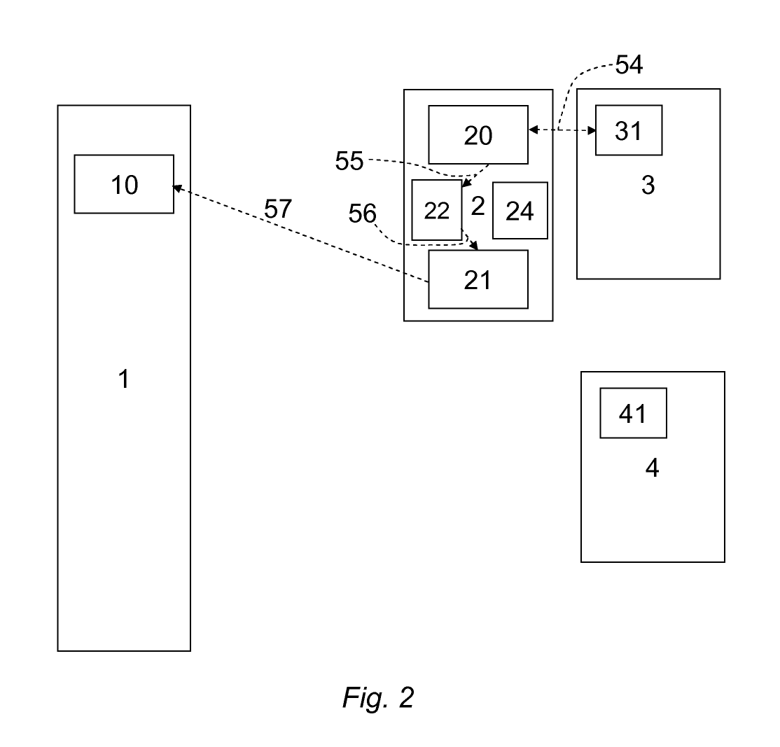

As shown in FIG. 2, the worker is supposed to demonstrate that he wears the accident prevention helmet 3.

Therefore, a tag 31 detection stage is provided. This is performed e.g. by the worker bringing the cellular telephone 2 closer up to a distance short enough to allow to establish a radio communication between said second radio communication means 20 and said tag 31.

In this way:
the tag 31 transmits its identifying code to the second radio communication means 20 by means of radio communication 54;
the microprocessor 22 acquires, by means of stage 55, the identifying code of the tag 31, which is associated with the safety helmet 3; the microprocessor 22 is thus able to detect that the worker wears the safety helmet 3.

A stage notifying detection of the tag 31 to the remote system 1 is obtained in the following way:
the microprocessor 22 issues a “helmet-worn” signal to the first radio communication means 21 by stage 56;
the first radio communication means 21 transmits the signal 57, that reports the notice of the safety helmet 3 being worn, to the third radio communication means 10.

At this point, the central system 1 acquires the information that the safety helmet is worn.

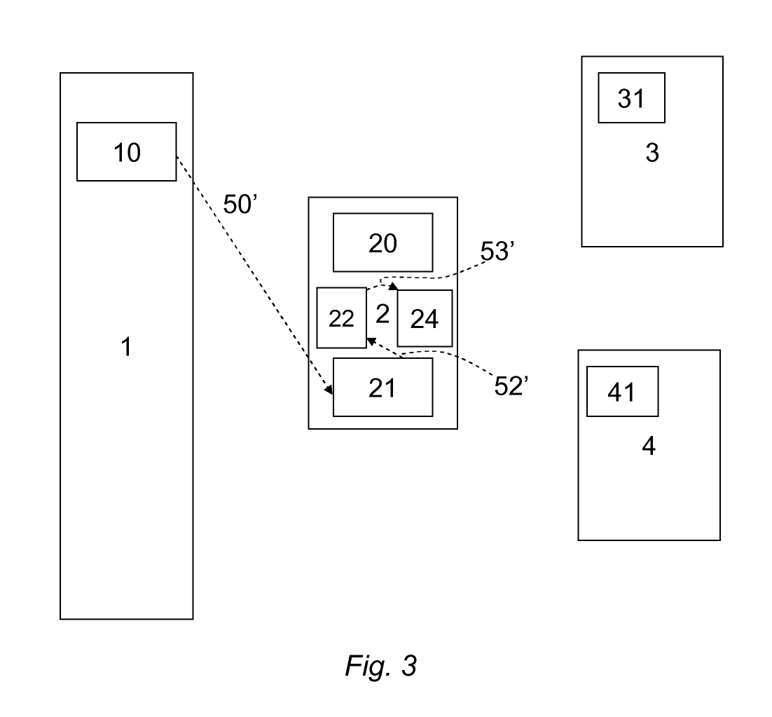

Thus, the central system goes on to the second operation step (putting on the accident prevention shoes), as illustrated in FIG. 3.

The worker is requested to put on the accident prevention shoes 4:
the remote system 1 transmits a request signal 50′ to the first radio communication means 21 of the cellular telephone 2; the request signal 50′ codifies an information about the request to wear the accident prevention shoes 4;
the microprocessor 22 acquires (stage 52′) the received request signal 50′; in this way, the microprocessor 22 is able to identify the meaning of the request signal 50′;
the microprocessor 22 asks (stage 53′) the input/output interface 24 to display the request to put on the accident prevention shoes 4.

The worker puts the accident prevention shoes 4 on.

The worker moves the cellular telephone 2 closer to the accident prevention shoes 4 up to a distance short enough to allow a radio communication between said second radio communication means 20 and the tag 41 associated with the accident prevention shoes 4.

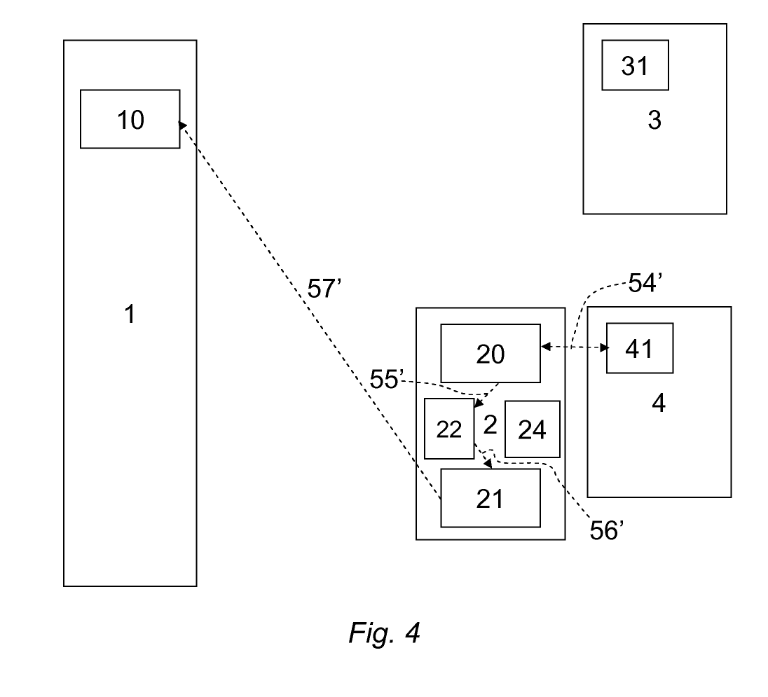

In particular, as represented in FIG. 4:
the tag 41 transmits its identifying code to the second radio communication means 20 by means of radio communication 54′;
the microprocessor 22 acquires, by means of the stage 55′, the identifying code of the tag 41, which is associated with the accident prevention shoes 4; the microprocessor 22 is thus able to detect the accident prevention shoes 4 being worn by the worker.

The stage of notifying the tag 41 detection to the remote system 1 is obtained in the following way:
the microprocessor 22 makes a “shoes-worn” signal available to the first radio communication means 21 by stage 56′;
the first radio communication means 21 transmits the signal 57′, which reports the notice of the accident prevention shoes 4 being worn, to the third radio communication means 10.

At this point, the central system 1 acquires the information that the shoes are worn.

Therefore, also the second operation step is completed.

Assuming the list of necessary operations required by the safety procedure included only the two operations here described (i.e. wearing helmet and protective shoes), the safety procedure is completed and the authorisation can be issued. As mentioned above, several solutions and different implementations are possible to issue such authorisation, e.g. a visual message can be displayed, a sound could be emitted or even switching means (e.g. connected to an access control gate) might be enabled, so that the requested operation can be performed by the user.

The first and the second operation steps can be repeated periodically, for example every three hours, so as to remind the worker to continue wearing the accident prevention clothes 3, 4. If this is not case, an alarm could be set to raise the attention and force the user to comply with the safety procedure.

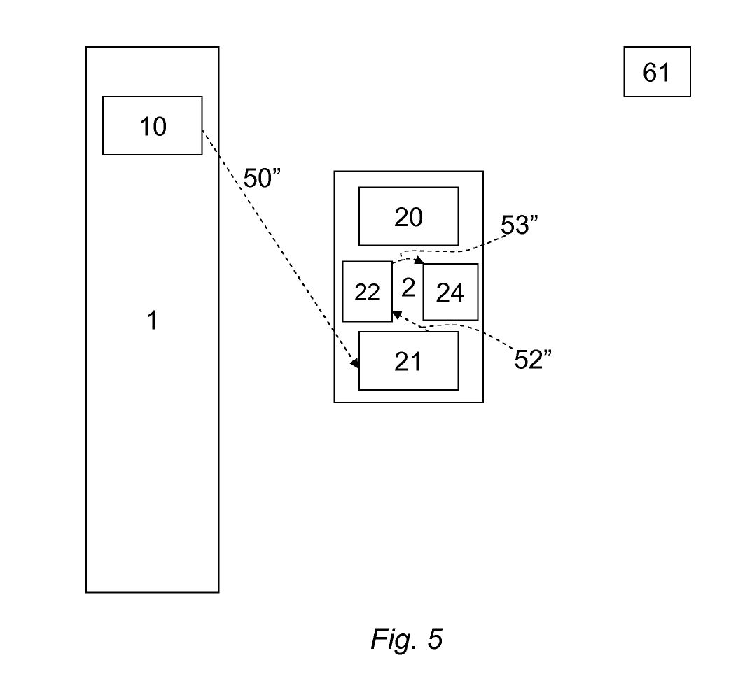

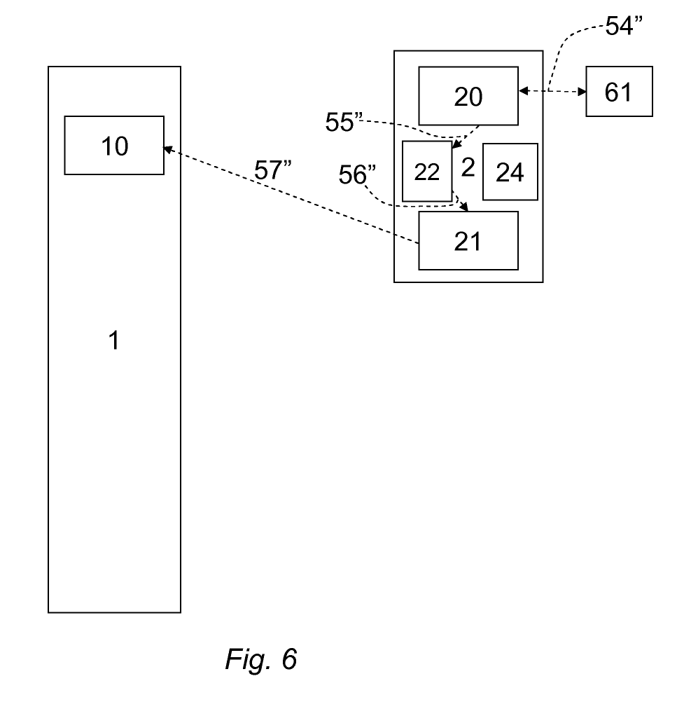

A second exemplary embodiment of the present invention is illustrated in FIGS. 5 to 8. Due to the similarity with the elements of the previous example, like elements will be indicated with like reference numbers.

This exemplary embodiment relates to carrying out of a maintenance operation, which must be performed by an operator in a determined cell of an industrial plant (but it could also concern the operator's entrance into a restricted area of a production cell for a standard operation).

As shown in FIG. 5, the cell is associated with a tag 61 of the same type as the above mentioned tags 31, 41, with the specification that the tag 61 is able to identify the cell in an unambiguous way.

The operator is equipped with a cellular telephone 2 of the same type as in the previous example, in particular with the same elements 20-24.

A remote system 1 is similar to the one of the previous example.

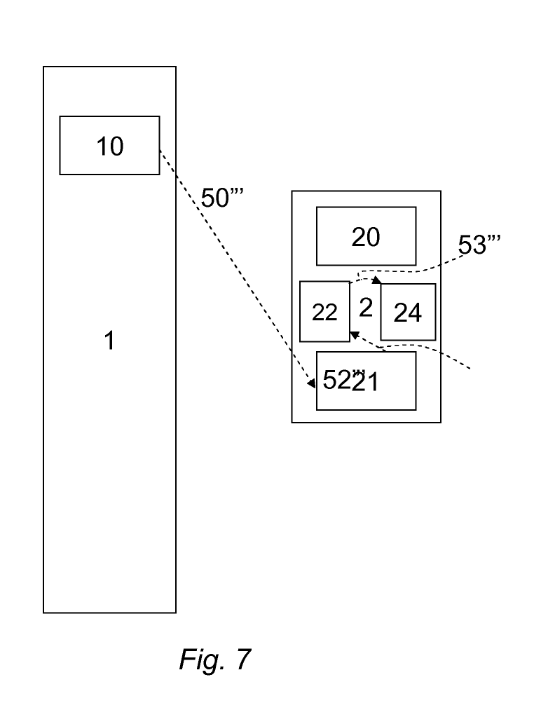

An operation step is provided, in which the operator moves close to the cell, where the maintenance is to be carried out. Carrying out of such operation step is described below:
the remote system 1 request to carry out this operation step; stages 50″ and 52″, analogous respectively to stages 50 and 52 of the previous example;
the input/output interface 24 displays this request, in which the cell where the maintenance is to be made, is clearly identified and described;
the operator moves toward the cell, in which the maintenance is to be made;
the tag 61 associated to said cell is detected by means of stages 54″ and 55″ (see FIG. 7), corresponding respectively to stages 54, 55 of the previous example;
said detection is notified to the remote system 1 by means of stages 56″, 57″, analogous respectively to stages 56, 57 of the previous example.

After this notice, the remote system 1 acquires the information that the operator has moved to the cell, in which the maintenance is to be made.

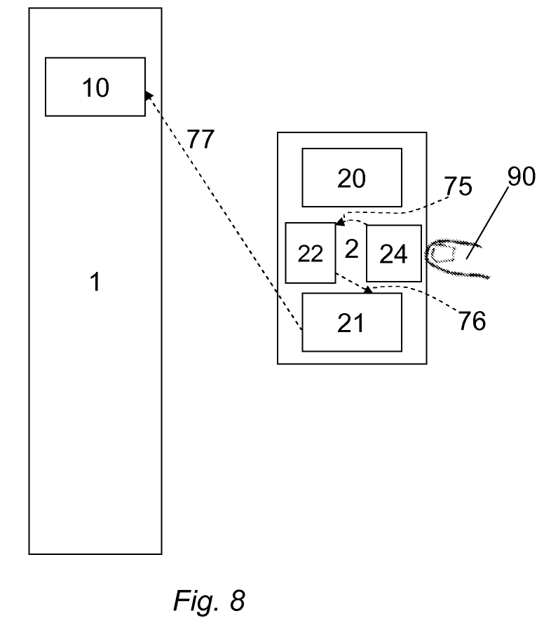

At this point, the remote system 1 begins a cyclical sending of information related to the maintenance operation to be made. This happens by means of stages 50″′, 52″, 53″′ (see FIG. 7), which are analogous to stages 50, 52, 53 of the previous example and to the display of the information reported on said input/output interface 24. For each information, the operator asks for enablement by pushing a predetermined key of the input/output interface 24, e.g. with finger 90 (see FIG. 8). By the finger 90 pressure, the enabling information is sent to the remote system 1 by means of stages 75, 76, 77.

In an embodiment of the present invention, the data communicated and stored between the remote system and the portable device are encrypted, so that external persons cannot access said data.

For both the above mentioned embodiments, the remote system can be generally connected to an internet/intranet type net, so as to allow control and supervision of the operations.

The remote system is also able to enter database related to various operators, said database having information about the single operators competence, their working hours and days. The remote system includes also a further database containing information about the operations to carry out and the standard procedures that must be followed in order to perform these operations. Thus, the remote system is capable of associating the operators with the tasks to be performed and to provide them automatically with the carrying out instructions, which can be then displayed by the portable device supplied to each operator. If necessary, this information can be downloaded directly from the company's information system, in particular from a managerial type system.

The use of computer systems allows also further functions, normally none provided for. For example, it is simple to control operations performed by the operators, since among the information exchanged between the portable device and the remote system, sending of time information (for example, the time in which the tag has been identified), the safety control (for example, by means of an unambiguous code assigned to the portable device of each single worker) are easily implemented.

It will be appreciated that the invention allows guiding an operator during the operation steps without making him confused.

In addition, the remote system is capable of describing exactly the operations without the necessity to generalize the concepts or elements.

The remote system can also acquire information related to the operators' working activities in real time, thus acting as a supervising system.

Furthermore, a higher safety level is obtained due to the fact that the safety information is substantially repeated and is always available.

Furthermore, it is also possible that the information visualized on the portable device change not only according to the procedure to be carried out, but also according to the operator: for example, carrying out instructions could vary depending on the language spoken by the operator and his skill level.

Normally the portable device, which is usually a cellular telephone, is lighter and easier to carry with respect to a paper manual.

It is to be noted that advantageously, the present invention not only allows safety standards that are higher with respect to the prior art, but it also makes available a traceability of the operations performed by the single operators. This is particularly advantageous for statistics of the workforce productivity, the certification of the carried out operations and the reconstruction of the events after an accident occurs.

It is to be noted that the use of radio power supplied tags is advantageous because it avoids the necessity of power supplying said tags via cables. With reference to the example reported in the prior art and related to the fact that the use of generalizations along with the use of variables (e.g. “x”, “y”) can be harmful for the safety, it is to be noted that the invention allows electronic visualization of messages without any variables, such as:
“disconnect the devices 3, 5” instead of: “disconnect the devices x, y”;
“re-connect only the device 3” instead of: “re-connect only the device x”.

This is possible just due to the fact that the capabilities offered by electronic systems are definitely more versatile with respect to paper solutions.

Alterations and modifications may be made to the above without departing from the scope of the invention. Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the computers have different structure or include equivalent units; in any case, it is possible to replace the computers, mobile phone, controller devices with any code execution entity (such a PDA and the like).

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibres, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for monitoring a plurality of entities by means of a controller device, the controller device including a proximity based communication transceiver, each of the plurality of entities including a proximity based tag adapted to interact with the transceiver, each tag carrying identity information adapted to identify the associated entity, the method including:
maintaining in a repository, accessible by the controller device, a list including a plurality of entities which must enter into the transmission range of the proximity based communication transceiver before the performance of an operation is authorized;
responsive to the detection of a tag within the transmission range, the controller device reading the information associated to the detected tag;
the controller device checking the inclusion of the entity corresponding to the read information in the list of entities;
responsive to all the entities of the list being detected the controller device issuing an authorization.

2. The method of claim 1 wherein the controller device issues an authorisation when all the entities of the list have been detected within a predetermined period of time.

3. The method of claim 1 wherein the controller device is a portable device.

4. The method of claim 1 wherein the proximity based communication transceiver is a NFC.

5. The method of claim 1 wherein the plurality of entities includes protective garments which must be worn by a user of the controller device before performing the operation.

6. The method of claim 1 wherein the repository is remote and the controller device accesses the repository by means of a network.

7. The method of claim 1 wherein the step of issuing an authorisation includes delivering a message to a user of the controller device.

8. The method of claim 7 wherein the message includes one or more of the following: a sound, a light, a flashing light.

9. The method of claim 1 wherein the controller device is connectable to apparatus switching means and the step of issuing an authorisation includes activating the switching means.

10. The method of claim 1 wherein the controller device is connectable to a server, the method further including:
reporting the detections of entities to the server.

11. A computer program comprising instructions for carrying out the steps of the method according to claim 1, when said computer program is executed on a computer.

12. A computer program product including computer readable means embodying the computer program of claim 11.

13. A controller device including a proximity based communication transceiver, the controller device having access to a repository containing a list including a plurality of entities which must enter into the transmission range of the proximity based communication transceiver before the performance of an operation can be authorized, the controller device being adapted to detect the presence of proximity based communication tags, each tag being associated to an entity and carrying identity information adapted to identify the associated entity, the controller device being adapted to authorize the performance of an operation only when all the entities of the list are detected.

14. A data processing system for monitoring a plurality of entities by means of a controller device, the controller device including a proximity based communication transceiver, each of the plurality of entities including a proximity based tag adapted to interact with the transceiver, each tag carrying identity information adapted to identify the associated entity, wherein the system comprises one or more components adapted to perform the method of claim 1.

15. An apparatus for controlling access to a restricted area including:
a data processing system for monitoring a plurality of entities by means of a controller device, the controller device including a proximity based communication transceiver, the controller device having access to a repository containing a list of compulsory entities, the controller device being adapted to detect the presence of proximity based communication tags, each tag being associated to an entity and carrying identity information adapted to identify the associated entity, the controller device being adapted to authorize the access to the restricted area only when all the entities of the list are detected; and
switching means being selectively operated by the controller device.
